(19) United States
(12) Patent Application Publication
(10) Pub. No.: US 2006/0145092 A1
(43) Pub. Date: Jul. 6, 2006

(54) Radiation monitor

(76) Inventors: Andrew Gunn, Angus (GB); Ian David Cameron, Dundee (GB); Dundan Stephen Pepper, Edinburgh (GB)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 10/547,639

(22) PCT Filed: Mar. 4, 2004
(86) PCT No.: PCT/GB04/00886

§ 371 Date: Aug. 31, 2005

(30) Foreign Application Priority Data
Mar. 4, 2003 (GB) 0304874.1

(51) Int. Cl. G01N 21/64

(52) U.S. Cl. 250/474.1; 436/172

(57) ABSTRACT

The present invention provides a method for monitoring temporal variation in irradiating radiation received by a material, comprising the steps of: providing a flow of an actinometric fluid (4) through a monitoring portion (22) of a passage (10), such that said actinometric fluid therein intercepts a flux of said irradiating radiation (13) representative of the flux of the radiation received by the material; and analysing said actinometric fluid (4) downstream of said monitoring portion (22) so as to measure a change in said actinometric fluid due to irradiation by said intercepted radiation flux. The invention also provides an apparatus for use in the above method.

The present invention relates to the field of monitoring irradiating radiation received by a material being irradiated.

There exists a significant problem in monitoring whether materials, which require to be treated with radiation, are being provided with and receiving adequate radiation throughout the course of their treatment. This problem is particularly critical where health and safety issues are involved if material is inadequately treated, and is especially relevant where a flow of blood, blood products or other body fluids, drinking water, foodstuffs, drugs, fermentation fluids, tissue culture products etc, is being irradiated with UV (usually UV-C) irradiation to inactivate micro-organisms. It is also an issue in certain industries, such as those where for example irradiation of printing inks and the curing of adhesives by UV radiation needs to be more or less carefully controlled.

To date electronic means have frequently been used to detect the level of radiation being emitted from a source (Ryer A., Light Measurement Handbook. International Light Inc. Mass. 01950. 1997) However, such methods fail to provide information on the radiation level that is actually received by the sample being irradiated because of the cumbersome size of the detectors which cannot readily be located in a suitable position for this. The size of the equipment is a major disadvantage where samples are being treated in apparatuses which are relatively small in comparison to the equipment.

Other approaches have adopted the science of actinometry using a chemical actinometric reagent, which undergoes a chemical reaction when it is irradiated, and detecting that reaction (Chemical Actinometry. Pure and Applied Chemistry Vol 61, No 2, 187-210, 1989). These approaches do not, however, provide any measure of the radiation received by a sample while the sample is actually being irradiated over a period of time, as they are used to flush the apparatus before and/or after irradiation (see for example WO00/20045 with reference to Example 5).

One method which has recently been proposed by Rahn (Rahn R. O., Xu P. and Miller S. L., “Dosimetry of Room-Air Germicidal (254 nm) Radiation Using Spherical Actinometry”, Photochemistry and Photobiology Vol 70, No 3, 314-318, 1999) measures germicidal ultraviolet radiation in an omnidirectional manner using actinometry, but this does not provide any real time information on the radiation received and is unsuitable for monitoring the radiation received by fluids such as blood in confined spaces inside processing apparatus.

It is an object of the present invention to avoid or minimise one or more of the present disadvantages.

The present invention provides a method for monitoring temporal variation in irradiating radiation received by a material during irradiation thereof, said method comprising the steps of:
a) providing a flow of an actinometric fluid through a monitoring portion of a passage, said monitoring portion of said passage being provided with wall(s) translucent to said irradiating radiation, said monitoring portion being formed and arranged such that said actinometric fluid therein intercepts a flux of said irradiating radiation representative of the flux of the said irradiating radiation received by said material during irradiation thereof; and
b) analysing said actinometric fluid downstream of said monitoring portion of said passage so as to measure a change in said actinometric fluid due to irradiation by said intercepted irradiating radiation flux.

Various actinometric fluids can be used in the method according to the invention. In general the actinometric fluid will undergo a change in optical spectral properties upon irradiation by said irradiating radiation. For example actinometric fluids which respond to radiation by undergoing a chromogenic change (i.e. a change in Absorbance at one or more wavelengths) to form a chromogen whose formation can be monitored, may be used. Such actinometric fluids will be referred to as chromogenic actinometers and include such chemical actinometric fluids as those described in Kuhn et al. (Kuhn H. J., Braslavsky S. E. and Schmidt R. “Chemical Actinometry”, Pure and Applied Chemistry Vol 61, No 2, 187-210, 1989) and Jankowski et al. (Jankowski J. J., Kieber D. J. and Mopper K. “Nitrate and Nitrite Ultraviolet Actinometers”, Photochemistry and Photobiology Vol 70, No 2, 319-328, 1999). Particularly convenient chromogenic actinometric fluids include potassium iodide, ammonium iodide, and, preferably, sodium iodide. It will be appreciated that the chromogenic change can be analysed by a number of techniques, most conveniently photometric methods using photometric apparatus, including spectrophotometric apparatus.

It will be appreciated by those skilled in the art that when the chromogenic change in the actinometric fluid is being analysed by photometric methods, the wavelength(s) at which the fluid should be analysed will be dependent on the particular actinometric fluid being used. The inventors have found it particularly convenient to use iodide actinometric fluids which upon irradiation produce iodine which gives rise to absorbance peaks at around 280 nm and around 352 nm. 280 nm photometers are widely used in chromatography and the like and are therefore readily and economically available. The double peak also facilitates verification of measurement obtained, by using different absorbance monitoring methods operating at the two different wavelengths.

Other actinometric fluids which may be used in the method according to the present invention include fluorescent actinometric fluids which respond to irradiating radiation by a change in fluorescence properties. Suitable fluorescent actinometric fluids include nitrate and nitrite actinometric agents (see Jankowski et al.).

The property change in the fluorescent actinometric fluid is generally analysed by spectrofluorimetry.

Although the following description of the invention is primarily in relation to the use of chromogenic actinometric fluids and analysis thereof using spectrophotometric analysis for the sake of convenience, it should be appreciated from the above that such references are not intended to be limiting and alternative actinometric fluids and analysis methods may be used instead.

It will be appreciated that the present invention is not limited to monitoring a particular type of irradiation. Whilst the invention may be particularly convenient for monitoring UV-C irradiation, other forms of irradiation, for example, UV-A and UV-B may be monitored instead of or as well as UV-C. Many of the materials suitable for use with UV-C radiation are also suitable for use when UV-A and/or UV-B radiation is being monitored. Jankowski et al. also describe particular actinometric fluids suitable for UV-A and UV-B radiation monitoring.

Some actinometric fluids undergo a stable or long term change in response to radiation. Such actinometric fluids are particularly convenient where the analysis is not carried out immediately or only some time after the actinometric fluid has been irradiated.

Other actinometric fluids undergo a temporary or reversible change when they are irradiated and it will be appreciated that a more rapid analysis of these actinometric fluids is required before the change decays. Such actinometric fluids include azobenzene, 8H,16H-4b, 12b-epidioxydibenzo[a,j]perylene-8.16-dione and E-[1-(2,5-dimethyl-3-furyl)ethylidene](isopropylidene)succinic anhydride. These actinometric fluids can be advantageous if it is desired to re-use the actinometric fluid following reversal of the actinometric change, which is economically advantageous and cuts down on waste disposal requirements.

It will be appreciated that the monitoring portion should in general be configured and arranged so that, on the one hand it receives a flux which is substantially representative of the flux received by the material being irradiated so that it can provide a reasonably reliable indication of any significant changes in the actual radiation dosage received by said material, without, on the other hand, unduly interfering with the irradiation of that material. It will further be appreciated in this connection that the configuration and arrangement required to achieve a suitably representative flux will depend on the nature and complexity of the radiation flux received by the material being irradiated. Thus for example, where the flux received by the material originates from multiple radiation sources in a more or less complex geometric array, with possibly optical radiation redirecting devices such as reflectors as well, it will be understood that a monitoring portion which is sensitive to change in any one of the radiation sources and/or optical devices, could well be significantly different from one sufficient to capture a flux representative of a much simpler radiation system such as a simple radiation source without any reflectors. It will be understood that the actinometric fluid can intercept the flux of radiation before or after the irradiating radiation from the radiation source has passed through material being irradiated.

It will also be understood that whilst it would normally be necessary to use a monitoring portion geometry which can provide a reasonably reliable qualitative indication of any changes in any part of the irradiation system, it would generally be more difficult to provide a monitoring portion geometry which can provide a more or less precise quantative indication of the change in radiation dosage received due to changes in different parts of the irradiation system in a complex multi-source radiation system due to the complex make-up of the flux received by the material, so that in at least some cases there may be used monitoring sections which provide only a qualitative indication of any significant change in any part of the radiation system.

By means of photometric or fluorometric analysis of the actinomtric fluid flow, it is possible to obtain an indication of any significant changes in the irradiating radiation flux received by the material being irradiated, thereby providing a reliable warning of the occurrence of any such changes. It will be appreciated that this indication may be captured in various different ways. Thus, for example, there may simply be compared the difference in chromogenic change for the whole of the actinometric fluid passed through the monitoring section over a given period of time, under each of control and test conditions. The measurements (which are differenced) may moreover be obtained by analysis of a sample of the whole actinometric fluid which has been collected and homogenized, or by integrating a series of successive photometric measurements of the actinometric fluid flow.

It is, though, a particular advantage of the method of the present invention that it makes possible a substantially real-time monitoring of changes in radiation dosage received by a material being irradiated which can be particularly valuable in cases where the material being irradiated is a flow of fluid. Thus, for example, in such a case, instead of having to dispose of the whole of a large body of fluid because of mixing of insufficiently irradiated material with properly irradiated material, it is now possible to immediately isolate the insufficiently treated material from that which has been correctly treated thereby avoiding wastage of the latter. Also irradiation processing can be temporarily halted whilst the irradiation system fault is corrected, and then resumed again with minimal wastage of material being irradiated and minimum down-time of the irradiation system.

Thus in a preferred form of the method according to the invention the analysis of said actinometric fluid is carried out directly on the flow of actinometric fluid through said passage so as to obtain a series of change measurements which may be correlated with the radiation flux at a particular time in the course of irradiation of the material. Advantageously said analysis is carried out substantially continuously.

Thus in further preferred form of the invention, there is included the further step of detecting any said variation in the quantum of the change in said actinometric fluid due to irradiation thereof, so as to detect a corresponding variation in flux of the radiation received by the material being irradiated.

In a further aspect the present invention provides an apparatus suitable for use in monitoring temporal variation in irradiating radiation received by a material during irradiation thereof which apparatus comprises an elongate capillary tubing having a capillary tubing inlet for connection, in use, to a reservoir for holding an actinometric fluid, said capillary tubing being formed of material substantially resistant to absorption of actinometric fluid components, in use of the apparatus, and said capillary tubing defining a passage for a flow of the actinometric fluid in use of the apparatus, therethrough, said capillary tubing being provided with a monitoring portion, said monitoring portion having walls translucent to said irradiating radiation, and the tubing adjacent said monitoring portion being formed and arranged so as to be substantially opaque to said irradiating radiation, said monitoring portion being disposable, in use of the apparatus, in close proximity to the material being irradiated, in use of the apparatus, and said monitoring portion being formed and arranged so as to be disposable, in use of the apparatus, such that said monitoring portion can intercept a flux of said irradiating radiation, in use of the apparatus, representative of the flux of said radiation received by the material being irradiated, in use of the apparatus.

Desirably the material of the capillary tubing (monitoring portion) does not absorb any of the components of the actinometric fluid. It is particularly important that components of the actinometric fluid, the absorption of which would reduce or interfere with the transmission of irradiating radiation through the tubing walls, or impede a chromogenic change in the actinometric fluid, are not absorbed.

The capillary tubing suitable for use in the present apparatus according to the present invention typically has a diameter of less than 3 mm, preferably less than 2 mm most preferably from 0.5 mm to 1.5 mm. It will be appreciated that, in general, the finer the bore size of the tubing the faster the response time of the actinometric fluid, the smaller the volume of actinometric fluid that is required to flow through the apparatus and the lower the running costs of the apparatus, and the less interference there is to radiation reaching the fluid being processed.

Preferably the capillary tubing is substantially flexible and can be readily bent to conform to the shape of a fluid processing apparatus component, such as an irradiation pipe section.

It has been found that there are a relatively limited number of suitable materials from which the capillary tubing can be formed. This is in part because the tubing must be translucent to the type of radiation being used to irradiate the material. It will be appreciated that different materials may be suitable for different radiation types. The tubing should also be substantially resistant to absorption of the actinometric components, the absorption of which can “foul” the tubing thereby reducing the transmission of radiation through the walls. Significant levels of absorption of actinometric components (by the tubing) can also reduce the accuracy of measurements of radiation received by the monitoring portion of the apparatus, since a proportion of the components will have been removed from the flow of the actinometric fluid, prior to measurement of the change therein.

Preferably the tubing material is also substantially resistant to degradation by the irradiating radiation. This is advantageous because it reduces the frequency at which the tubing needs to be replaced. It is also desirable for the tubing to have relatively good tolerance to heat because it will be appreciated that it may be exposed for extended periods of time, to radiation sources such as UV lamps.

Where the irradiating radiation being used to irradiate a material is UV-C, suitable materials for the monitoring portion include polyethylene, polypropylene, polyfluoroacrylate (PFA), preferably fluorinated ethylene propylene (FEP), and polytetrafluoroethylene (PTFE). These materials have a particularly low level of absorption of actinometric fluid components and absorb only very small amounts of components such as iodine (a commonly used component of actinometric fluids), over long periods. This reduces the frequency at which replacement tubing is required. Surprisingly it has been found that commercially readily available PTFE chromatography connector tubing is particularly suitable for use in accordance with the present invention.

One of the particularly surprising features of the present invention is that while the above described materials which are suitable for the tubing when UV-C irradiating radiation is being monitored may have a relatively low UVC radiation transmission level in comparison to materials more typically used, such as silica, the apparatus and method of the present invention generally results in a very strong chromogenic change which can readily be detected by photometry or spectrophotometry.

The capillary tubing inlet may be connected to a reservoir for holding the actinometric fluid by various coupling devices which will be well known to those of ordinary skill in the art such as push-fitting onto nozzle components, compression fittings. Preferably the apparatus is provided with at least one valve for controlling actinometric fluid flow from the reservoir into the capillary tubing.

Typically the apparatus is provided with a pump to control and regulate the flow of actinometric fluid from the reservoir and through the apparatus. Alternatively the actinometric fluid may be supplied to the apparatus by gravity feed. Preferably the apparatus is provided with an adjustable flow rate control means for adjusting the actinometric fluid flow rate to a value that provides a suitable residence time of the actinometric fluid within the monitoring portion. The sensitivity of the apparatus is in part dependent on the volume of actinometric fluid exposed to the irradiating radiation and hence the internal diameter of the tubing and the length of the monitoring portion, as well as the rate of flow of the actinometric fluid, are chosen to provide the desired sensitivity. Suitable values can be readily determined empirically.

It is generally convenient to provide the apparatus with a pressure monitor to check that the fluid flow system is functioning appropriately or within pre-set parameters.

The apparatus may also be provided with a feedback control circuit in which the actinometric fluid change measurements are used to adjust the operating parameters of the irradiation apparatus, for example, the flow rate of the fluid material being irradiated.

It will be appreciated that the arrangement of the tubing in relation to the material being irradiated will in part be dependent on the geometry and type of material being irradiated as well as the arrangement and orientation of the radiation sources and the examples given hereinbelow are not to be considered as limiting. Thus, for example, where the material being irradiated is a fluid flowing through a treatment pipe of a processing apparatus, the capillary tubing could simply be run along the length of the pipe. Preferably the tubing would be run within the pipe, most preferably coaxially. It will be appreciated that where the material being irradiated has a low absorption level for the irradiating radiation (i.e. a high radiation transmission level) it would generally be suitable to have the tubing arranged inside the pipe. The monitoring portion could extend along the entire length of the treatment pipe or a part thereof. It will be appreciated that a capillary tubing with a monitoring portion arranged coaxially with a process pipe would be particularly advantageous where the process pipe is irradiated omni-directionally or from multiple radiation sources around the pipe's circumference. By positioning the monitoring portion at the centre of the tube, the apparatus can be used to sense a change in radiation which it intercepts from any direction. It will be appreciated that where a simpler radiation system is used, for example the process pipe receives a radiation flux from one direction only, the monitoring portion could be run along the length of the process pipe and suitably positioned to intercept the radiation flux, preferably directly between the radiation source and the process pipe.

Alternatively the monitoring portion could be in the form of one or more monitor loops extending around the circumference of the outer wall of the treatment pipe. Such an arrangement is desirable, or in some cases may be necessary, where the material being irradiated has a more or less high absorbance level for the irradiating radiation such that most or all of the radiation would have been absorbed by the material, before it can be intercepted by the monitoring portion so that a reasonable representation of the flux received by the material could not be obtained. Desirably the tubing leading to and from the monitor loop would be opaque to the irradiating radiation in order to minimise the likelihood of the actinometric fluid intercepting radiation, before it reaches a monitoring zone suitable for intercepting a suitably representative radiation flux—typically around the outer wall of the treatment pipe. The monitoring section loop is preferably disposed in close contact with the treatment pipe. Such monitoring loops are particularly useful in monitoring the average or integrated radiation flux around the surface of process pipes where the distribution of irradiating radiation is not radially symmetrical.

By using highly flexible capillary tubing, the monitoring section can be readily bent and shaped to conform with the contours of the material being irradiated (or a vessel e.g. pipe containing it). This is particularly relevant where irregularly shaped materials are involved.

The sections of tubing adjacent the monitoring portion can be provided with a screening covering which is substantially opaque to the irradiating radiation in various different ways, for example, sections of tubing adjacent the monitoring portion could be formed of a different material, to the material of the monitoring portion, the material used for the adjacent sections of tubing being opaque, and the sections simply connected together to form a continuous passage for the actinometric fluid. In the case of UV-C irradiation suitable materials for the opaque sections include pigmented PTFE or PEEK (polyether ether ketone) tubing. Alternatively the sections of tubing adjacent the monitoring portion could be provided with an outer sheath of a radiation opaque material which could be painted, taped, adhered or secured by other suitable means. Suitable materials include pigmented heat shrink tubing or white opaque teflon, which is conveniently available in the form of plumber's tape.

In one form of the apparatus where an outer sheath of radiation opaque material is provided, a gasket can be provided at the junction between the sheath and the monitoring portion. The gasket can act as a “radiation-tight plug” to physically anchor the sheathing at a defined point and accurately delineate the section of tubing exposed to the irradiating radiation i.e. the monitoring portion.

In an alternative form of the invention the outer sheath and inner tubing could be in sliding fit connection enabling the size of the monitor loop to be adjusted by varying the amount of tubing concealed by the sheath. Such an arrangement would be advantageous where a single apparatus could be adjusted to fit around materials of different size or circumference, such as pipes of different diameter.

It will be appreciated that the extent and form of radiation shielding required will be influenced by the type of irradiating radiation being used. For example, where the irradiating radiation being used falls within, for example, the visible spectrum then all the usual precautions to avoid exposure of the actinometric fluid to daylight would be adopted.

In some circumstances it may be advantageous to provide further shielding from the irradiating radiation, in addition to the hereinabove described sheathing. For example, if it is desired to restrict the direction from which the monitoring portion received irradiating radiation, the monitoring portion can be provided with partial (directionally selective) screening. This could take the form of an irradiating radiation opaque channel within which the monitoring portion could be positioned. Alternatively the region of the monitoring portion to be shielded could be coated or sheathed in a similar manner to that described hereinabove for the sections adjacent the monitoring portions. This may be advantageous where it is desired to avoid detecting secondary radiation such as light reflected from or transmitted through, the pipe from an original unidirectional radiation source.

In a form of the apparatus where the monitoring portion extends along the length of a process pipe, outside the pipe, and the process fluid (material being irradiated) has a high absorption level for the irradiating radiation, it may be convenient to provide shielding between the monitoring portion and the process pipe. This can prevent the actinometric fluid experiencing an initial high level of radiation which is unrepresentative of that to be experienced by the process fluid, due to additional radiation which has passed through the process pipe when the radiation source is first switched on and before the process fluid enters the process pipe adjacent the monitoring portion. This would result where the pre-process contents of the pipe have a low absorption level for the irradiating radiation, for example, water or air. Without the shielding, radiation from a source which passes through the process pipe, which, during operation of the apparatus, would be absorbed by the process fluid prior to reaching the monitoring portion, would otherwise cause an actinometric change in the actinometric fluid, unrepresentative of the flux which would actually be experienced by the process fluid in proximity to the monitoring portion during operation of the apparatus. It will be appreciated that such shielding would be unnecessary where the process fluid and the pre-process contents of the process pipe have similar absorption levels for the irradiating radiation.

In order to give a more representative indication of the flux of the radiation experienced at the circumference of the sample being irradiated, the monitoring apparatus according to the present invention may also be provided with an additional, outer covering, layer of the same material as that used in the walls of the process pipe (or other receptacle) within which the material being irradiated is irradiated. For example, where a FEP process pipe is used for the material being irradiated, a covering layer of FEP may be provided around the monitoring portion, conveniently in the form of heat shrunk FEP around the monitoring portion. Advantageously the covering layer would be of equivalent thickness to that of the wall of the process pipe or other receptacle. A monitoring portion covered in this way could also be provided with further shielding as described hereinabove.

Where the actinometric fluid undergoes a reversible change in response to radiation and the actinometric fluid is to be reused it may be convenient to provide the apparatus with a return connection for returning the analysed actinometric fluid to be passed through the apparatus again. The apparatus may also be provided with a device which accelerates the reversal of the actinometric change. For example, where the reversal can be accelerated by heat a heater element can be provided in the circuit loop. Such a heater element may also serve to de-gas the recirculating actinometric fluid by increasing the temperature of the fluid, thereby reducing the formation or occurrence of bubbles in the fluid which could impede the effectiveness of the apparatus and monitoring of the irradiating radiation.

Alternatively, the returning actinometer fluid may be regenerated by irradiation with visible light, at a wavelength chosen to photobleach the chromogen.

The apparatus is preferably provided with a temperature sensor to monitor the temperature of the actinometric fluid. This is advantageous because the actinometric fluid may be sensitive to temperature variation which could affect the chromogenic change in the actinometric fluid. Preferably the temperature sensor is formed and arranged to monitor the temperature of the actinometric fluid after it has intercepted the irradiating radiation in the monitoring portion. Suitable temperature sensors include generally needle-shaped positioned thermocouples within the capillary tubing.

The apparatus of the invention may also be provided with a cooling system to regulate the temperature of the apparatus and/or actinometric fluid. Suitable cooling systems are generally well known in the art and need no further explanation here. The cooling system may conveniently be arranged to respond appropriately in response to changes detected by a temperature sensor provided for monitoring the temperature of the apparatus and/or actinometric fluid, where temperature is being regulated.

Preferably the portion of the capillary tubing downstream of the monitoring portion is arranged to pass directly through a photometer monitor. The photometer monitor is generally equipped with a light source of suitable wavelength to detect a chromogenic change in the actinometric fluid relative to actinometric fluid which has not been irradiated by the irradiating radiation. It will be appreciated that irradiation with the wavelength of the optical radiation for detecting a chromogenic change preferably should not itself result in a chromogenic change of the actinometric solution. Those skilled in the art will be aware of suitable wavelengths of light for analysing different actinometric fluids.

Suitable path lengths through the actinometric fluid for the spectrophotometric analysis can also be readily determined according to standard procedures. The choice of wavelength of the light and the path length can be readily chosen to provide a level of sensitivity of photometric analysis which is insensitive to the intrinsic absorption of the un-irradiated actinometric fluid but able to detect an anticipated change resulting from irradiation of the actinometric fluid in the monitoring portion of the apparatus.

It is convenient for the photometer monitor to be provided with a chart recorder or other visual display for recording the signal from the photometer monitor. Alternatively or additionally the results from the photometer could be logged to a data logging programme on a PC or further transformed by mathematical algorithm into relative or absolute dose units.

In another form of the apparatus of the invention the portion of the capillary tubing downstream of the monitoring portion can be provided with an outlet for transferring the irradiated actinometric fluid into a collection vessel and the collected actinometric fluid analysed by photometry, spectrophotometry or spectrofluorimetry at a later time. Preferably the collection vessel would be in the form of a time/volume fraction collector. Such collectors are well known in the art and are used to collect individual volumes of fluids during a specified time period.

As noted above, the wavelengths used for monitoring chromogenic changes with iodide-based actinometric fluids, are in the non-visible spectrum, and thus cannot be observed with the naked eye. Another practical difficulty is that iodine is rather reactive, so that the stability of the chromogen is rather poor, which restricts the use of such actinometers where it is desired to delay the monitoring of the chromogenic changes for one reason or another.

We have surprisingly found, though, that certain additives may be incorporated in such actinometric fluids, which significantly improve the stability of the chromogen, and in some cases also provide chromogenic changes which can be observed with the naked eye, and improve the quantum efficiency thereof, without significantly interfering with the preferred monitoring wavelength at 280 nm. More particularly it is known that various detergents (both non-ionic and zwitter-ionic) and various polymers can modify the chromogenic response with iodide actinometers, so as to provide a visible colour change. Most of these, however, suffer from significant disadvantages such as being themselves absorbing at the preferred 280 nm monitoring wavelength, containing peroxides which can give false positives, and reacting with iodine so as to create turbidity which also interferes with monitoring of the chromogen. We have now surprisingly found that a small minority of these, which can be readily identified by simple trial and error, avoid one or more of these disadvantages, and a significant number (several of which are identified in the Examples provided hereinbelow), not only improve the stability of the chromogen, but also increase quantum efficiency and shift the wavelength of one or more absorption peaks sufficiently far towards the visible region to allow monitoring with the naked eye, without however significantly interfering with the preferred chromogen monitoring wavelength of 280 nm—either through absorption by the additive itself or by shifting the absorption peak used for this purpose too far away from 280 nm.

Thus in a preferred form of the invention there is used an iodide chromogenic actinometric fluid, which includes a, detergent and/or polymer, additive, which can form a complex with iodine, which complex increases the stability of the iodine, and/or substantially increases the absorption of the iodine in the visible spectrum, and which additive does not itself have any significant absorption at 280 nm, is not susceptible to the formation of turbidity in the presence of iodine, and is substantially free of peroxide moieties.

As used herein the term “complex” simply indicates an association between the additive and the iodine entity which reduces the freedom of interaction of the iodine with the aqueous medium to a greater or lesser extent, and may be one or more of an electrochemical interaction, a physical encapsulation etc.

The invention will now be further described with particular reference to the following examples and drawings wherein:

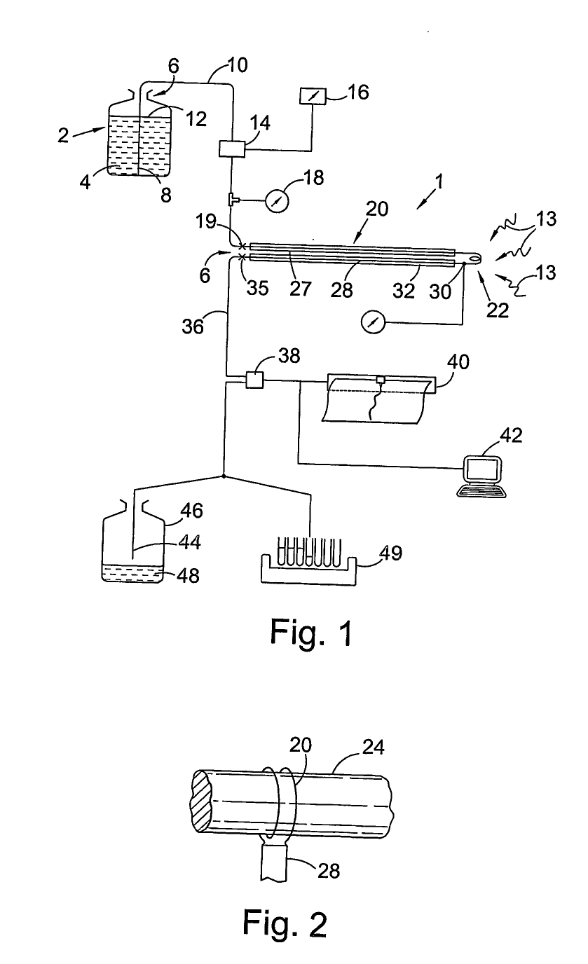

FIG. 1 is a schematic diagram which comprises an apparatus according to the present invention;

FIG. 2 shows a perspective view of the monitoring portion of the apparatus of FIG. 1 positioned around a process pipe, shown in part;

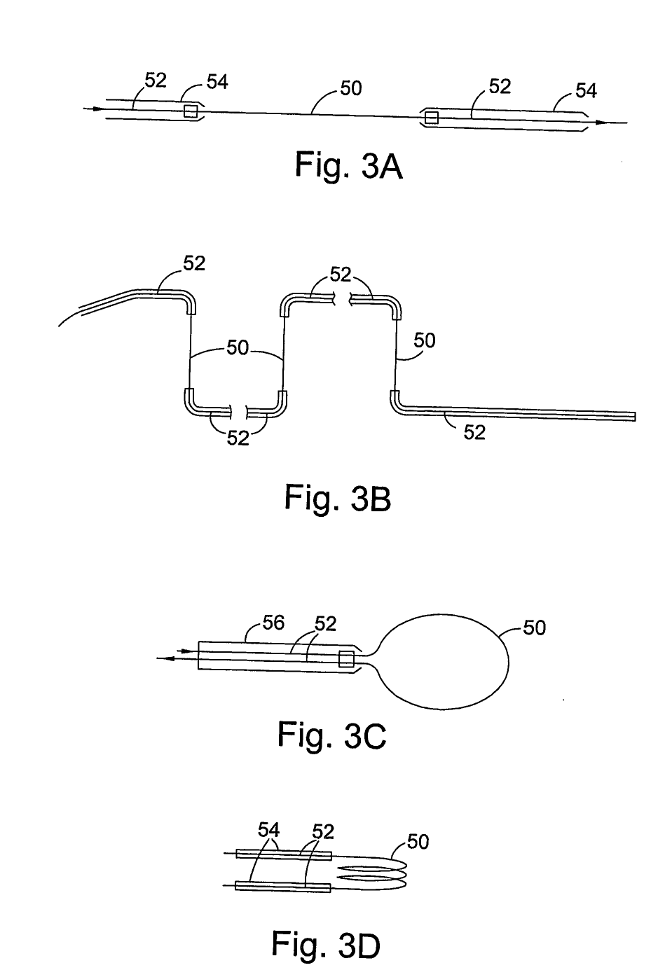

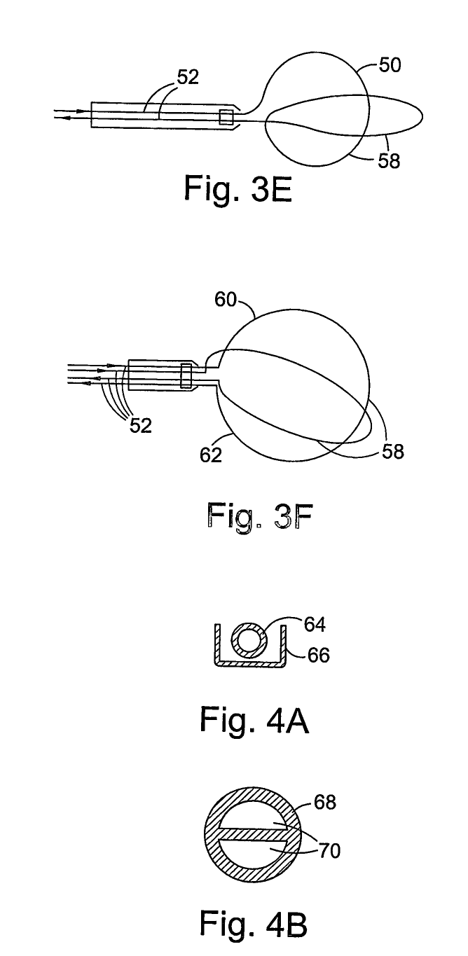

FIGS. 3A to 3F are prospective views showing different configurations of the monitoring portion of the apparatus according to the present invention;

FIGS. 4A and 4B are cross-sectional views of the capillary tubing of two embodiments of the apparatus according to the present invention;

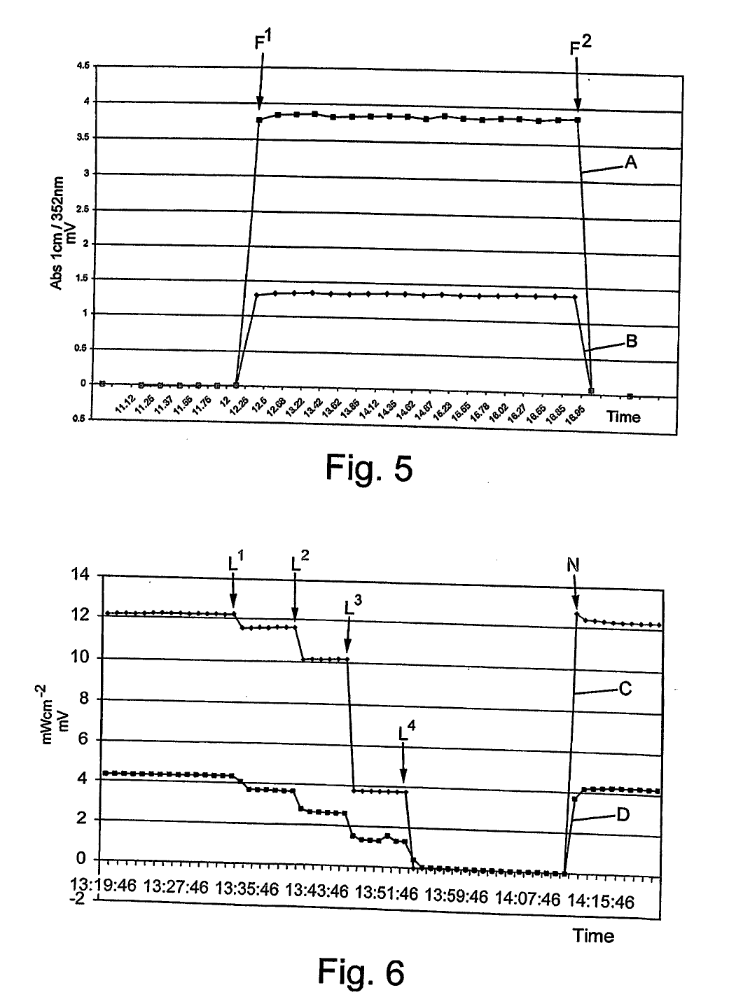

FIG. 5 shows the Absorbance results against time for the experiment described in Example 9 herebelow;

FIG. 6 shows the readings of the power monitor (upper curve C) in mWcm⁻² and the photometer reading of the actinometric fluid in mV (lower curve D) when the four UV-C lamp sources are sequentially switched off and then simultaneously on as described in Example 10; and

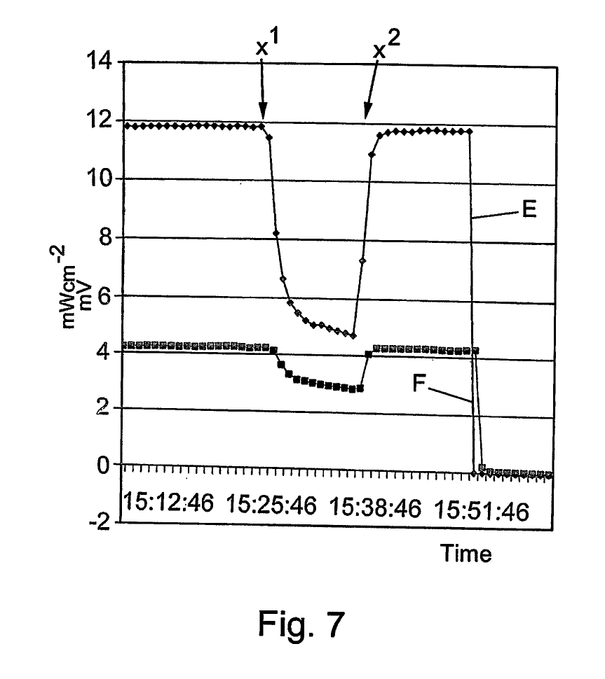

FIG. 7 shows the flux of the lamp output in mWcm⁻² (upper curve E) and voltage spectrophotometer readings of the actinometric fluid (lower curve F) in mV when lamp cooling fans are switched off and on, as described in Example 11.

The diagram of FIG. 1 comprises an apparatus according to the present invention, indicated generally by reference number 1. The apparatus 1 comprises a 2 litre glass bottle 2 containing an actinometric fluid 4.

One end 8 of a capillary tubing 10 is located in the glass bottle 2 with the opening of the capillary tubing below the surface 12 of the actinometric fluid 4. The apparatus of FIG. 1 is suitable for use in monitoring temporal variation in UV-C radiation 13 received by a process pipe such as that previously described in WO00/20045 with reference to FIGS. 1 and 2. When the four lamps, not shown, providing the UV-C irradiation (indicated by zig zag arrows) are operating the bottle and leading portion of the capillary tubing 6 are positioned outside the zone of potential UV-C irradiation. The capillary tubing 10 is formed of PTFE tubing (Polypenco Ltd; Welwyn Garden City UK) and has an internal diameter of 0.79 mm and an outer diameter of 1.61 mm. A micro gear pump (Michael Smith Engineering Ltd., Woking, UK, Micropump Series 188-361) 14 is used to drive the actinometric fluid 4 through the capillary tubing 10 from the glass bottle 2. The flow rate of the actinometric fluid is controlled by a variable DC power supply (Radiospares Ltd., Thandar TS3021S, part no 653-165) 16 which powers the pump 14. A pressure monitor with a pressure display monitor (monitor—Elcomatic Ltd., Glasgow, UK, Utah Medical Products DPT—200, display monitor—Radiospares Ltd., Corby, UK, Druck Pressure Monitor, part no 648-763) 18 is connected to the output of the pump 14, which monitors the flow of actinometric fluid 4 through the capillary tubing and can be used to check that the flow system is functioning accordingly to preset parameters.

The end of the capillary tubing 19 leading from the pressure monitor 18 is connected using chromatography tubing couplers (Omnifit Ltd., Cambridge, UK, part no 2310), to a one metre length of PTFE chromatography connector capillary tubing 20. A length of approximately 80 mm in the centre of the capillary tubing 20 is formed into a double loop formation 21. The double loop of tubing forms the monitoring portion 22 of the apparatus and the loops 21 can be positioned around a process pipe 24 of a fluid process apparatus (such as that previously described in WO00/20045 with reference to FIGS. 1 and 2), as shown in FIG. 2. Locating the monitoring portion 22 in close proximity to and around the circumference of the process pipe 24 results in the monitoring portion 22 being located so as to receive a highly representative and substantially equivalent flux of irradiation as the process pipe 24 receives. The loops 21 are retained in close proximity to the surface of the process pipe by tightening and securing the loops 21 with a Nylon component tie wrap (Radiospares Ltd., Corby, UK, Part No 622-133) wrapped around the end portions of the monitoring portion.

At both ends 23 of the monitoring portion 22, pieces of adhesive tape approximately 1 mm to 2 mm wide were wound around the tubing 20 to form small cylindrical gaskets 26. Excess tape was removed with a scalpel. Two 35 cm to 40 cm lengths of UV-C opaque heat shrink polyolefin tubing (Radiospares Ltd., Corby, UK Part No 252-8128, 3.0 mm dia, shrink ratio 3:1) were slipped over the capillary tubing 20 adjacent to the monitoring portion such that the inner margin of the gaskets 26 aligned with the inner margins of the heat shrink polyolefin tubing and the heat shrink polyolefin tubing was heat shrunk over the capillary tubing 20 adjacent to the monitoring portion to form two sheathed shielded sections of capillary tubing upstream 27 and downstream 28 of the monitoring portion.

During operation of the apparatus 1 the monitoring portion 22 and majority of the sheathed sections 27, 28 are housed in a reflective housing (not shown) which surrounds the UV-C sources and process pipe 24 such that the monitoring portion 22 is the only portion of UV-C translucent capillary tubing located within the zone of potential UV-C irradiation.

The monitoring portion provides an exposed length of tubing of a known illuminated length and a known illuminated volume. In conjunction with a defined flow rate, there is then a defined residence time within the illuminated volume. There are also defined internal and external illuminated surface areas corresponding to the internal and external diameters of the sensor tubing. Depending on the spatial distribution of the UV radiation to be detected, the monitoring portion also has associated cross sectional areas of the inner and outer surfaces which act to intercept, react with and sense the UV radiation.

A temperature sensor in the form of a thin needle shaped thermocouple 30 is located in proximity to the junction where the monitoring portion 22 meets the downstream shielded portion of tubing 28. The thermocouple 30 monitors the temperature of the actinometric fluid 4 following its exposure to UV-C radiation and a temperature recorder 34 provides actinometric fluid temperature data to enable corrections to be made to account for temperature dependant chromogenic changes.

The free end 35 of the downstream sheathed shielded portion of tubing 28 is connected, using chromatography tubing couplers, as described above, to capillary tubing 36 feeding a continuous flow chromatography photometer monitor (Chronos Express Ltd., Macclesfield, UK, part no DS014-0012-280NM, equipped with a DS025-0021 semi-prep 2.5 mm path length flow cell) 38 (not shown in detail)

The photometer monitor 38 is provided with a suitable detector, amplifier and linearisation circuitry and the results of the photometer can be displayed visually on a chart recorder 40 connected to the photometer monitor 38. The apparatus is also provided with a PC 42 connected to the photometer monitor 38 into which results and data from the photometer can be logged using a data logging package such as that available from Adept Scientific Ltd., Letchworth, UK, part no DASYlab DS-12-8-TC.

The outlet 44 of the flow cell of the photometer was fed into a second 2 litre glass bottle 46 and the actinometric fluid flowing from the photometer was collected in the bottle 46. The collected actinometric fluid 48 can be discarded or analysed further. The actinometric fluid flowing from the photometer can also be connected to a time/volume fraction collector 49 which can be used if further analysis of volumes of the fluid collected over particular periods during the operation of the is apparatus desired.

In FIGS. 3A to 3F the direction of flow of actinometric fluid through the capillary tubing of the apparatuses is indicated by arrow heads. FIG. 3A shows part of an apparatus which has a linear configured monitoring portion 50 and linear sections of tubing adjacent to the monitoring portion 52, provided with a UV-C opaque sheath 54 as described for the sections of tubing adjacent to the monitoring portion 27, 28 of FIG. 1. The linear configuration of FIG. 3A is particularly useful where the radiation being monitored is isotropic or radially symmetrical. The linear configured tubing may conveniently be positioned to run through the interior (preferably along the central axis) of the process pipe of a processing apparatus, thereby giving an indication of the irradiating radiation received at the centre of the processing pipe where the process fluid has sufficiently low absorbance for the monitoring portion to receive a reasonably measurable and representative flux of the irradiating radiation.

In FIG. 3B a series of parallely disposed linear monitoring portions 50 are connected by sheathed sections of tubing adjacent to the monitoring portions 52. This configuration is useful when monitoring the individual or summed output of multiple lamps which are used in large processing arrays.

FIGS. 3C and 3D show monitoring portions shaped into a looped configuration. A single (FIG. 3C) or multiple (FIG. 3D) loops can be formed. Instead of each section of capillary tubing adjacent to the monitoring portion 52 being provided with separate sheaths of heat shrunk UV-C opaque polyolefin tubing 54 as in FIG. 3D, in FIG. 3C a single sheath 56 is heat shrunk around the adjacent sections of tubing 52. This loop configuration is useful for monitoring the average or integrated illumination around the surface of a process pipe.

FIG. 3E shows a configuration where a single monitoring portion of capillary tubing 50 is formed into two loops 58 orientated at right angles with respect to each other and the adjacent sections of tubing 52 are shielded in a single sheath as in FIG. 3C.

FIG. 3F also has two loops 58 which are orientated at right angles with respect to each other, but unlike FIG. 3E the loops 58 are formed from separate pieces of capillary tubing 60, 62 and the four sections of adjacent tubing 52 are sheathed together in a similar way to the two sheathed sections of FIG. 3C.

The configurations of FIGS. 3E and 3F can be used to approximate to a spherical response to irradiating radiation. FIG. 3F is of particular use where the spatial distribution is unknown or variable as a comparison of the chromogenic change of the actinometric fluid flowing through the loops, 60, 62 can additionally provide an indication of the spatial distribution of the irradiating radiation. Alternatively a double loop configuration as shown in FIG. 3F could be formed by two connector sections of tubing, from which the respective loops are formed, which are connected to common actinometric fluid supply and return tubing. This can facilitate formation of the double loop which has been found to quite awkward due to the mobility of the fine tubing.

The configurations shown in FIGS. 3C to 3F can be provided with oscillatory, vibrating or rotation mechanisms which drive the monitor portion of the apparatus resulting in the moving monitor portion sweeping out a virtual sphere in space. This is beneficial as a spherical radiation monitoring response can be achieved regardless of the spatial distribution of the irradiation radiation. By providing a faster rate of motion of the monitoring portion than the response time of the apparatus the resulting signal will be smoothly integrated.

In FIG. 4A a section of capillary tubing 64 of the monitoring portion is shown in cross-section which is mounted in a C shaped channel 66 formed of any convenient material substantially opaque to UV-C irradiating radiation (e.g. PVC, brass, stainless steel) which restricts the spatial sensitivity of the monitoring portion to one axis. This arrangement is useful to obtain a pseudo-collimated radiation beam e.g. when calibrating the response of the actinometric fluid with the actinometric fluid tube mounted alongside an electronic sensor so as to receive a generally similar radiation flux. The channel is also of use for physically mounting the apparatus where physical support is not available.

A particularly convenient channel to shield the inner portion of a monitoring portion that has been formed into a loop configuration around a process pipe can be made by bonding together two superimposed ‘O’ rings which are formed of a UV-C opaque material such as viton™. The junction of the ‘O’ rings forms a groove within which the monitoring loop can be positioned and the ‘O’ rings shield the monitoring loop from secondary radiation which has passed through the process pipe or has been reflected from elements within the process pipe.

In FIG. 4B a section of capillary tubing 68 is shown in cross section which has the lumen divided into two channel compartments 70. Actinometric fluid can be passed through one of the channels while a suitable cooling fluid can be passed through the other channel.

### EXAMPLES

### Example 1

### Demonstration of Method of and Apparatus for Monitoring UV Radiation

The glass bottle of FIG. 1 was filled with 2 L of 1% w/v sodium iodide in 10 mM Tris pH 7.5, actinometric fluid containing 2 ppm of SDS (sodium dodecyl sulphate) surfactant or any other convenient surfactant in order to minimise bubble attachment to the walls of the actinometric fluid flow circuit. The power supply to the pump was set at 12.00 Volts and the pump flow rate was measured as 3.7 ml/min. A standard 280 nm photometer monitor was switched on and allowed to warm up for 30 mins, on a range setting of 0.5 absorbance units. After warming up the output of the photometer monitor was zeroed using the auto-zero control and the chart recorder was zeroed manually on the 10 mV scale. The contribution of absorbance at 280 nm from the non-irradiated actinometric fluid was routinely less than 0.1 mV, (equivalent to A 1 cm/280 nm of 0.02). When the pump was stopped and the actinometric fluid was left in the flow cell (path length 2.5 mm, volume 44 μl) a negligible increase in baseline reading due to irradiation of the actinometer solution by the 280 nm illumination source in the monitor resulted, (less than 0.1 mV in 10 minutes). Switching on the four lamps showed a rise in the recorded actinometric fluid signal to 3.93 mV with a half-response time of about 0.5 min. The lamps finally reached equilibrium after about 10 minutes warming up, at which point the lamp surface temperatures were in the range 50-60° C. and the flux at their surface as measured with an electronic UV radiation meter (Uvitech Ltd., St Johns Innovation Centre, Cambridge, CB4 4WS. Part No UVImeter RX003) was 21.7 mW/cm². The experiment was continued for a period of 4 hours with water pumped through the process pipe at 800 ml/min to simulate flow of feedstock. The recorded actinometric fluid signal of approximately 5 mV did not vary by more than ±0.1 mV throughout this period indicating that both the lamp output of UV-C and the apparatus circuit were stable for an extended period. At the end of the experiment, the lamps were switched off and the actinometric fluid signal was allowed to return to baseline. The final recorded baseline reading was within 0.1 mV of the initial baseline reading set at the beginning of the experiment.

### Example 2

### Use of Apparatus with PTFE Tubing for Actinometric Fluid Flow

The apparatus was operated as described in Example 1 except that the effluent irradiated actinometer fluid was sampled at about 2 hours and 20 ml was collected for spectrophotometric scanning in 1 cm silica cells, according to standard procedures, approximately 60 mins after collection. This showed an absorbance A 1 cm/352 nm of 0.68, which from a previously constructed calibration curve for this actinometric fluid corresponded to a work density of 348 mJ/cm³. The sensor loop had an illuminated volume of 0.0402 ml and at a flow rate of 3.7 ml/min (equivalent to 0.0617 ml/sec) giving a residence time of 0.65 sec. Thus the work density of 348 mJ/cm³ corresponded to a power density of 535 mW/cm³. From the loop geometry and assuming semi-annular irradiation, we calculated that for every 1.00 ml of illuminated volume, there is an associated surface area of 25 cm², so the above power density corresponded to an apparent flux of 21.4 mW/cm², which was in very good agreement with the electronic meter reading. This implies a percentage transmission of PTFE of 99% ((21.4 mW/cm²)/(21.7 mW/cm²)) which is improbably high. The inventors propose but are not bound by the following possible explanation, that the outer wall of the tubing acts as an optical collector, doubling the cross sectional area which is intercepting the UV light and scattering it into the lumen of the detector loop. When the above figures are recalculated with a surface area to volume ratio of 50:1 a reasonable transmission of 50%. results. The high level of transmission indicates that the apparatus of the present invention using PTFE tubing can operate at high efficiency without the need to use expensive or fragile silica/quartz tubing.

### Example 3

### Use of Apparatus with FEP Tubing for Actinometric Fluid Flow

An apparatus was constructed as described in FIG. 1, but using FEP tubing (Adtech Polymer Engineering, part no HW20, id 0.86 mm, od 1.68 mm) and the apparatus was operated as described in Example 1. The recorded voltage from the photometer monitor was 3.7 mV, and the signal was stable for 4 hours, indicating that PTFE tubing can be substituted with FEP tubing.

### Example 4

### Use of Apparatus with Polyethylene Tubing for Actinometric Fluid Flow

A monitoring portion was constructed from polyethylene catheter tubing (Sims Portex, Hythe, UK Part No 800/100/140) with an inner diameter (id) of 0.4 mm and an outer diameter (od) of 0.8 mm, having an exposed length of 145 mm. The tubing was terminated at either end by inserting 23 gauge stainless steel hypodermic syringe needles. The assembly was wound twice around a compact UV-C source lamp (Phillips TUV 9W PL-S) of 9W power. The irradiated section was defined and the loops simultaneously anchored firmly in place by slipping a sheath of 6 mm id polyurethane tubing over the free ends of the sensor loop. The actinometric fluid as described in Example 1 was pumped through the sensor loop at 1.5 ml/min. The photometer monitor was set at 0.5 AU (Absorbance Units) scale and the chart recorder showed a stable signal of 3.5 mV after the lamp warmed up. An electronic sensor placed on the surface of the lamp recorded an irradiance of 22.7 mW/cm².

### Example 5

### Use of Apparatus with ETFE Tubing for Actinometric Fluid Flow

The experiment was as described in Example 4 except that the monitoring portion was formed into a single loop constructed from Tefzel (Trade Mark) tubing, (DuPont, Wilmington, Del., USA), ETFE (ethylene tetra fluoroethylene) capillary chromatography connector tubing, 1.6 mm od and 0.5 mm id with an exposed illuminated section of 80 mm length. Actinometric fluid as described in Example 1 was pumped through the tubing at 3.7 ml/min and the photometer monitor recorded a stable output of 3.5 mV, indicating that ETFE tubing is suitable material for the monitoring portion.

### Example 6

### Use of Apparatus with KI Actinometric Fluid

The experiment was as described in Example 5 except that the monitoring portion was formed into a single loop constructed from FEP with an illuminated length of 80 mm and the actinometric fluid consisted of 1.1% w/v potassium iodide in place of sodium iodide buffered to pH 7.5. This was pumped through the monitor loop at a flow rate of 9.7 ml/min and a 20 ml sample was collected and scanned in a spectrophotometer. It gave an absorbance A 1 cm/352 nm 0.6.

### Example 7

### Use of Apparatus with NH₄I Actinometric Fluid

The experiment was as described in Example 6 except that the actinometric fluid consisted of 0.97% w/v ammonium iodide buffered to pH 7.5. This was pumped at a flow rate of 9.7 ml/min and a 10 ml sample was collected and scanned in a spectrophotometer giving an absorbance of A 1 cm/352 nm of 0.6.

### Example 8

### Use of Apparatus with Polyethylene Tubing and NaI Actinometric Fluid

The experiment was as described in Example 5 except that the monitoring portion was composed of polyethylene tubing (Sims Portex, Hythe, UK, part no 800/100/280, od 1.52 mm and id 0.86 mm) with an exposed length of 80 mm. The actinometric fluid consisted of 1% w/v sodium iodide solution buffered to pH 7.5 and was pumped at a flow rate of 9.7 ml/min and 10 ml was collected, scanned in a spectrophotometer and found to have an absorbance A 1 cm/352 nm of 0.6.

### Example 9

### Use of Apparatus for Long-Term Stability Monitoring

Samples of actinometric fluid which had been passed through the monitoring portion of an apparatus as described in Example 1, were collected over timed 3 minute periods approximately every 15 minutes. The volume collected was determined by weighing. The samples were analysed after one hour according to our standard manual actinometry assay method using absorption at 352 nm and the results were compared with the chart recorder output obtained as described in Example 1.

The absorbance measurements obtained directly from the PC and chart recorder (mV) and from the 3 minute collections analysed normally at 352 nm (Abs 1 cm/352 nm) are shown in FIG. 5 which shows the directly measured Absorbance monitor signal (mV), upper curve A, and collected sample Abs 1 cm/352 nm, lower curve B, against time.

The absorbance results correspond and show consistent steady readings. The times at which the UV-C lamps were switched on and off are indicated by F¹ and F², respectively, and are clearly shown by the sharp increase and decrease, respectively, in absorbance readings.

### Example 10

### Use of Method to Monitor Changes in UV Radiation

To investigate the effect of switching off the four angularly distributed UV-C lamps providing the irradiating radiation to the apparatus as described in FIG. 1, the lamps were switched off sequentially and then all four lamps were switched on again simultaneously.

FIG. 6 shows the flux reading of the power monitor in mWcm⁻² (upper curve C) and the voltage reading in mV of the photometer reading of the actinometric fluid (lower curve D) against the time as recorded by the PC in hours, minutes and seconds. When each lamp is switched off at points indicated by L¹, L², L³ and L⁴ there is a sharp decrease in the flux reading and a corresponding decrease in the voltage reading of the 280 nm photometer.

When the four lamps are simultaneously switched on again, at the point indicated by N in FIG. 6, both the flux and voltage readings rapidly increase returning to the initial levels thereof prior to switching off of the first light.

The results show the apparatus responds rapidly to an alteration in the level of the radiation received by the apparatus, thereby providing a highly effective real-time monitor for detecting such changes.

### Example 11

### Use of Method to Monitor Changes in Temperature

To investigate the effect of temperature changes of the lamps of an apparatus as described in FIG. 1, the apparatus was provided with an inlet fan directed towards one end of the lamp cluster and an outlet fan for extracting air from the other end of the lamp cluster. The outlet fan was shown to be the more effective of the two fans according to standard smoke tests. FIG. 7 shows the flux reading of the power monitor in mWcm⁻² (upper curve E) and the voltage reading in mV of the 280 nm photometer reading of the actinometric fluid (lower curve F), against the time as recorded by the PC in hours, minutes and seconds.

At time 15.24, indicated by X¹, the inlet and the outlet fans were switched off which had a dramatic effect on the flux and voltage readings, both of which dropped rapidly due to a substantial increase in temperature of the lamps causing the lamp output to decrease.

At time 15.36, indicated by X², the inlet and the outlet fans were switched on again and the flux and voltage readings rapidly returned to their previous levels indicating the normal apparatus operating conditions had been re-established.

### Example 12

### Use of Apparatus with Alternative Detergent in the Actinometer Fluid

The apparatus was operated as described in Example 1 except that the sodium dodecyl sulphate was replaced with 0.05% w/v Cremophor EL (BASF Reg™; Sigma C 5135) detergent derived from castor oil and ethylene oxide. This detergent shifted the 288 nm peak to 292 nm and the 352 nm peak to 364 nm and consequently improved the visibility by the human eye considerably yet surprisingly still allowed monitoring at 280 nm. The optical density of the collected irradiated fluid decreased by 4% in 4 days compared to 40% decrease in 24 hours in the absence of this additive. The optical densities recorded in the monitoring device were also increased approximately 3 fold presumably due to an increasing quantum efficiency.

### Example 13

### Use of Apparatus with Alternative Detergent in the Actinometer Fluid

The apparatus was operated as in Example 12 except that the Cremophor EL detergent was replaced with Zwittergent 3-14 (0.05% w/v; CALBIOCHEM 693017) detergent. The wavelength peaks were again shifted to 292 nm and 360 nm and the loss of the formed chromogen on storage was only 1% in 4 days. No spontaneous generation of chromogen was observed in the absence of irradiation. Both the visibility and optical density were significantly improved.

### Example 14

### Use of Apparatus with Polymer Additive

The apparatus was operated as in example 12 except that the Cremophor EL detergent was replaced with 0.1% w/v polyvinylalcohol (mol. wt. ^{˜}100,000). Absorption peaks were recorded at 288 nm and 352 nm and a third visible absorption peak appeared at 497 nm giving a strong visible red-brown colour. Surprisingly, monitoring was still possible at 280 nm and the stability of the formed chromogen showed only 4% loss over 4 days. There was no effect on the quantum efficiency.

### Example 15

### Use of Apparatus with Polymer Additive

The apparatus was operated as in example 12 except that the Cremophor EL detergent was replaced by 0.1% w/v hydroxyethyl starch (ds 0.1; SIGMA H6382). This showed absorption peaks at 300 nm and 536 nm. Surprisingly, it was still possible to monitor the chromogen at 280 nm. This reagent gave a strong visible blue colour which was stable with only 1% loss over 4 days. Importantly, unlike the conventional starch reagent, it had no tendency to form precipitates which tend to block the capillary sensor tube.

1. A method for monitoring temporal variation in irradiating radiation received by a material during irradiation thereof, said method comprising the steps of:
a) providing a flow of an actinometric fluid through a monitoring portion of a passage, said monitoring portion of said passage being provided with wall(s) translucent to said irradiating radiation, said monitoring portion being formed and arranged such that said actinometric fluid therein intercepts a flux of said irradiating radiation representative of the flux of the said irradiating radiation received by said material during irradiation thereof, wherein said flow of actinometric fluid is arranged for intercepting said flux of radiation before the irradiating radiation from the radiation source has passed through material being irradiated; and
b) analysing said actinometric fluid downstream of said monitoring portion of said passage so as to measure a change in said actinometric fluid due to irradiation by said intercepted irradiating radiation flux.

2. A method as claimed in claim 1 wherein is used an actinometric fluid which is a chromogenic actinometer which responds to radiation by undergoing a chromogenic change.

3. A method as claimed in claim 2 wherein is used an iodide chromogenic actinometer.

4. A method as claimed in claim 1 wherein said actinometric fluid is analysed by photometry.

5. A method as claimed in claim 1 wherein is used an actinometric fluid which is a fluorescent actinometric fluid which responds to irradiating radiation by a change in fluorescence properties.

6. A method as claimed in claim 5 wherein is used an actinometric fluid which is a nitrate or nitrite fluorescent actinometer.

7. A method as claimed in claim 5 wherein said actinometric fluid is analysed by spectrofluorimetry.

8. A method as claimed in claim 1 wherein is used an actinometric fluid which undergoes a temporary or reversible change when irradiated, and where said method includes the further step of recycling said actinometric fluid.

9. A method as claimed in claim 1 wherein the analysis of said actinometric fluid is carried out directly on the flow of actinometric fluid through said passage so as to obtain a series of change measurements which may be correlated with the radiation flux at a particular time in the course of irradiation of the material.

10. A method as claimed in claim 9 wherein said analysis of said irradiated actinometric fluid is carried out substantially continuously.

11. A method as claimed in claim 1 wherein said irradiated actinometric fluid is collected in a collection vessel prior to said analysis thereof.

12. A method as claimed in claim 11 wherein said irradiated actinometric fluid is collected in a fraction collector.

13. (canceled)

14. A method as claimed in claim 1 wherein is included the further step of detecting any said variation in the quantum of the change in said actinometric fluid due to irradiation thereof, so as to detect a corresponding variation in flux of the radiation received by the material being irradiated.

15. A method as claimed in claim 1 wherein is used an iodide chromogenic actinometric fluid, which includes a detergent and/or polymer additive, which can form a complex with iodine, which complex increases the stability of the iodine, and/or substantially increases the absorption of the iodine in the visible spectrum, and which additive does not itself have any significant absorption at 280 nm, is not susceptible to the formation of turbidity in the presence of iodine, and is substantially free of peroxide moieties.

16. An apparatus suitable for use in monitoring temporal variation in irradiating radiation received by a material during irradiation thereof which apparatus comprises an elongate capillary tubing having a capillary tubing inlet for connection, in use, to a reservoir for holding an actinometric fluid, said capillary tubing being formed of material substantially resistant to absorption of actinometric fluid components, in use of the apparatus, and said capillary tubing defining a passage for a flow of the actinometric fluid in use of the apparatus, therethrough, said capillary tubing being provided with a monitoring portion, said monitoring portion having walls translucent to said irradiating radiation, and the tubing adjacent said monitoring portion being formed and arranged so as to be substantially opaque to said irradiating radiation, said monitoring portion being disposable, in use of the apparatus, in close proximity to the material being irradiated, in use of the apparatus, and said monitoring portion being formed and arranged so as to be disposable, in use of the apparatus, such that said monitoring portion can intercept a flux of said irradiating radiation, in use of the apparatus, representative of the flux of said radiation received by the material being irradiated, in use of the apparatus, wherein said monitoring portion is arranged for intercepting said flux of radiation before the irradiating radiation from the radiation source has passed through the material being irradiated.

17. An apparatus as claimed in claim 16 wherein the tubing adjacent said monitoring portion has walls translucent to said irradiating radiation, and is provided with a discrete screening cover substantially opaque to said irradiating radiation.

18. An apparatus as claimed in claim 16 wherein the tubing adjacent said monitoring portion has walls which are substantially opaque to said irradiating radiation.

19. An apparatus as claimed in claim 16 wherein said capillary tubing has a diameter of less than 2 mm.

20. An apparatus as claimed in claim 19 wherein said capillary tubing has a diameter of from 0.5 mm to 1.5 mm.

21. An apparatus as claimed in claim 16 wherein the capillary tubing is substantially flexible and can be readily bent to conform to the shape of a fluid processing apparatus irradiation pipe section.

22. An apparatus as claimed in claim 16 wherein said capillary tubing monitoring portion is of a material selected from polyethylene, polypropylene, polyfluoroacrylate (PFA), fluorinated ethylene propylene (FEP), and polytetrafluoroethylene (PTFE).

23. An apparatus as claimed in claim 16 wherein is provided a pump to control and regulate the flow of actinometric fluid through the apparatus.

24. An apparatus as claimed in claim 16 wherein is provided an adjustable flow rate control device for adjusting the actinometric fluid flow rate to a value that provides a desired residence time of the actinometric fluid within the monitoring portion.

25. An apparatus as claimed in claim 16 wherein is provided a feedback control circuit in which the actinometric fluid change measurements are formed and arranged for interfacing with the irradiation apparatus, in use of said monitoring apparatus, so as to adjust at least one operating parameter of the irradiation apparatus.

26. An apparatus as claimed in claim 16 wherein said monitoring portion is provided with a selective screening so as to permit interception of irradiating radiation from only a predetermined direction(s) by said actinometric fluid, in use of the apparatus.

27. An apparatus as claimed in claim 16 for use with an actinometric fluid which undergoes a temporary or reversible chromogenic change, wherein is provided a device which accelerates the reversal of the chromogenic change, downstream of a chromogenic change monitoring station through which said capillary tubing is routed.

28. An apparatus as claimed in claim 27 wherein said device comprises a heater element.

29. An apparatus as claimed in claim 27 wherein said device comprises a visible light irradiation device, having an operating wavelength for photobleaching of said chromogen.

30. An apparatus as claimed in claim 16 wherein is provided a temperature sensor to monitor the temperature of the actinometric fluid after it has intercepted the irradiating radiation in the monitoring portion, in use of the apparatus.

31. An apparatus as claimed in claim 16 wherein is provided a cooling system to regulate the temperature of the apparatus and/or actinometric fluid.

32. An apparatus as claimed in claim 16 wherein the portion of the capillary tubing downstream of the monitoring portion is arranged to pass directly through a photometer monitor.

33. An apparatus as claimed in claim 16 wherein said capillary tube monitoring portion is disposed in relation to an irradiation receiving component of an irradiation processing apparatus, so as to intercept a flux of said irradiating radiation representative of the flux of the said irradiating radiation received by material during irradiation thereof in said processing apparatus.

34. An apparatus as claimed in claim 33 wherein said component is a pipe and wherein said capillary tube monitoring portion is routed so as to extend at least one of along and around the exterior of said pipe.
